(19) United States
(12) Patent Application Publication
(10) Pub. No.: US 2007/0250546 A1
(43) Pub. Date: Oct. 25, 2007

(54) Burn log files

(76) Inventors: Dietmar Muhlhausser, Nurnberg (DE); Alexander Neagu, Erlangen (DE)

Correspondence Address: BRINKS HOFER GILSON & LIONE, P.O. BOX 10395, CHICAGO, IL, 60610, US

(21) Appl. No.: 11/410,372

(22) Filed: Apr. 25, 2006

(51) Int. Cl. G06F 17/30

(52) U.S. Cl. 707/202

(57) ABSTRACT

A system and method for simplification of burning log files onto an external medium is disclosed. Specifically, a computing system records log files relating to any system processes and the log files are selected to be transferred to an external media. The log files stored on the external media may be used for diagnostic purposes to locate and correct errors occurring on the computer system.

### BACKGROUND

The present disclosure relates to saving burn log files for transfer to an external medium or over a network.

As medical diagnostic and medical imaging equipment grows increasingly sophisticated, it becomes more difficult to monitor the entire operation of the devices. For example, when a complex computer system breaks down, it may be very complicated to determine the exact cause of the failure. The reason for this difficultly can be attributed to the complexity of the software necessary to run the equipment. In a very large software platform, an error may be very difficult to detect.

Computer software may have the ability to create log files that are records of events that occurred in the running of the software programs. Examples of systems that have logging systems in place include process control systems and the black box recorders installed in aircraft. Many operating systems and other computer programs have some form of data logging. The logged data may include an automatic recording of certain events to provide an audit trail to determine the source of any problems.

The stored log files may be compressed to be stored more efficiently. The log files may be created for the storage of important system information or may monitor all events. The log files may be stored locally on a computer hard drive. Transferring log files to an external medium requires a number of steps depending on the software or hardware of the system. For example, a user attempting to copy log files to an external medium must go through a variety of steps in order to transfer log files onto the external medium such as the following WINDOWS example:
1. Open Service and select “Utilities”
2. Select Escape to OS from the selection bar.
3. Enter “spsavelogs” in the parameter line.
4. Click Go to update the current LogFile.zip.
5. Enter “Explorer” in the parameter line.
6. Click Go to open Windows Explorer. Since the new Explorer window pops up in the background, you have to minimize the Local Service window.
7. Select and copy extracted files from <C:\“medhome”\service\extract> to the CD-R drive.
8. Double click on the CD-R drive icon to open it.
9. Click with the right mouse button into this drive and select “Write these files to CD”.
10. Continue with the “CD Writing Wizard”

Transferring log files to an external medium is cumbersome and requires significant interaction with the WINDOWS operating system. An improved method for transferring log files to an external media may improve the usability of various software platforms.

### BRIEF SUMMARY

By way of introduction, the embodiments described below include a system, method and computer readable media instructions for burning important system data, such as log files, onto an external medium. Specifically, a simplified method is disclosed for storing important system data onto an external medium. The external media may be a memory device, such as a compact disc (“CD”), digital video disc (“DVD”), memory card, or related device with storage capabilities.

In a first aspect, a method is provided for storing log files in a computer. The method includes: maintaining a database of log files, wherein each of the log files is a record of at least one event; displaying at least a portion of the log files; allowing a selection of at least one log file to be burned; compressing the selected at least one log file; and transferring the compressed selected at least one log file to an external medium.

In a second aspect, a system is provided for transferring log files. The system includes a processor; a database coupled with the processor for storing log files; a display coupled with the processor and configured to display a list of at least one of the stored log files; a communication port coupled with the processor; and external media, wherein the external media is coupled with the processor and configured to receive selected log files through the communication port.

In a third aspect, a system is provided for storing and transferring medical log files. The system includes a medical device configured to generate medical data; a processor coupled with the medical device and configured to process the medical data; a communication port coupled with the processor and configured to transmit and receive the medical data; a database coupled with the processor for storing the medical data, the medical data including log files, the log files including events from the medical device or the processor; a display coupled with the processor and configured to display a list of the log files that can be selected and transferred; and external media coupled with the communication port and configured to receive the selected log files from the database through the communication port.

In a fourth aspect, a computer readable storage medium includes instructions executable by a programmed processor for transferring log files for medical software. The instructions include: recording an event log of events in the medical software; providing a mechanism in the medical software for displaying the event log; allowing for a selection of events from the displayed event log; and burning the selected event log files to an external media.

The present invention is defined by the following claims, and nothing in this section should be taken as a limitation on those claims. Further aspects and advantages of the invention are discussed below in conjunction with the embodiments.

### BRIEF DESCRIPTION OF THE DRAWINGS

The components and the figures are not necessarily to scale, emphasis instead being placed upon illustrating the principles of the invention.

FIG. 1 is a block diagram showing one embodiment of a system in which burn logs may be created;

FIG. 2 is a flowchart diagram showing one embodiment for storing burn logs;

FIG. 3 is a flowchart diagram showing an alternate embodiment for storing burn logs;

FIG. 4 is an image of one step of an embodiment for storing burn logs;

FIG. 5 is an image of an additional step of an embodiment for storing burn logs; and

FIG. 6 is an image of an additional step of an embodiment for storing burn logs.

### DETAILED DESCRIPTION OF THE DRAWINGS AND THE PRESENTLY PREFERRED EMBODIMENTS

System data or log files are created by monitoring the events of the system. The log files include information relating to the functions of a system, including its hardware and/or software, and are particularly useful if an error or failure occurs. The log files may be used to pinpoint the cause of the problem by identifying the event that was the cause of the failure and/or the time of the failure. Specifically, the method for transferring or burning log files does not require the steps illustrated in the background for burning log files to a CD.

Throughout this disclosure log files may also be referred to as burn log files. Likewise, the log files may be referred to as being burned onto an external media. Despite being most applicable to burning data to a CD or DVD, this phrase is meant to cover any form of a transfer of data onto any external media.

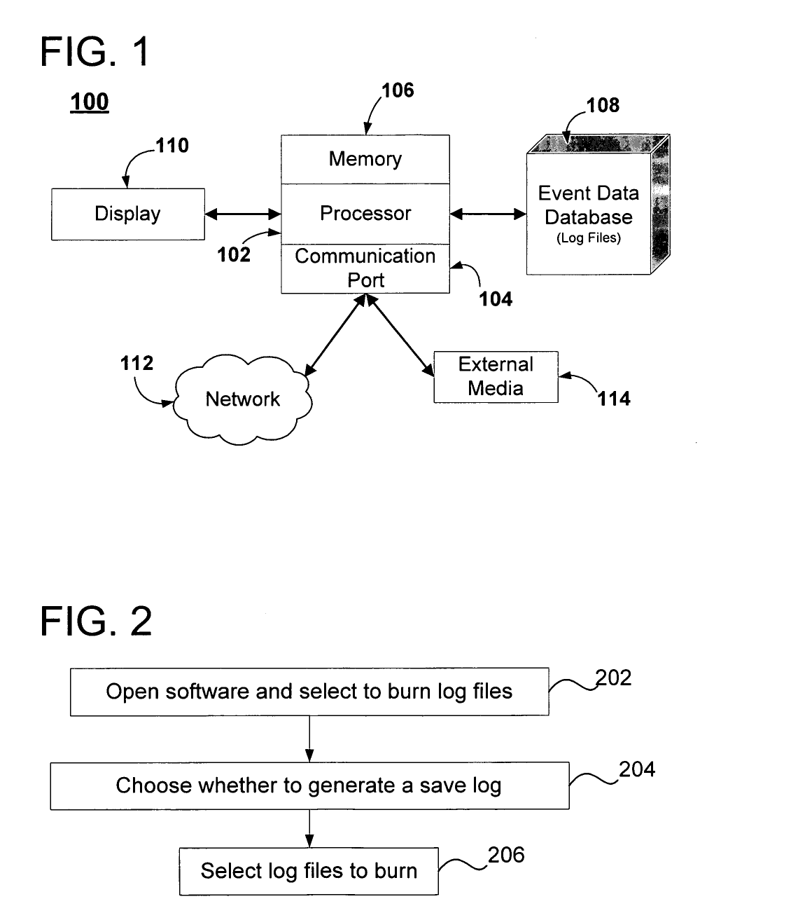

FIG. 1 is a block diagram showing one embodiment of a system 100 in which burn logs may be created. The system 100 includes a processor 102 coupled with a memory 106 and a communication port 104. The processor 102 is further coupled with a display 110 and a database 108. The communication port 104 is configured to connect with a network 112 and/or interact with external media 114.

Additional, different or fewer components may be provided. The system 100 may include a personal computer, workstation, network, or other now known or later developed system for processing data. In one embodiment, the system 100 includes a medical device coupled with or including the processor 102 or the database 108. The medical device is operative to perform a function or produce data. One example is a medical imaging device that stores images. Accordingly, the system 100 may be a computer aided system for any medical diagnosis, treatment, or medical procedure. In alternate embodiments, other devices that produce data or perform a function may be coupled with the system 100 and the operation of that device may be logged according to the embodiments discussed below.

A record of event log files may be provided such that the log files are a record of the actions taken by the system. For example, in a medical imaging device coupled with the processor 102 and operative to store image data in the database 108, the log files record the steps preceding the imaging as well as the images. The log files may record all inputs or actions by the user as well as the system response and all internal processes in the device and the processor 102. The log files can then be used for error analysis if the imaging fails. Less than all the events, inputs, actions, response or internal processes may be included in the log files.

In one embodiment, the transfer of log files to an external device may be necessary for error analysis. The log file data may be too large to transmit over a network 112 or may be unreachable if only stored locally. For an isolated imaging device, a device failure may not be repairable on site. The transfer of the event logs to an external device can be used to transport the data to a diagnostic and analysis headquarters, technician, or a more convenient location. The external device may also protect sensitive data in case of a hard drive, memory, or database failure. In an alternate embodiment, the log files may be transmitted over the network 112.

The processor 102 may be a component in a variety of systems. For example, the processor 102 may merely include a standard personal computer. The processor 102 may be one or more general processors, digital signal processors, application specific integrated circuits, field programmable gate arrays, servers, networks, digital circuits, analog circuits, combinations thereof, or other now known or later developed devices for processing data and creating log files.

The processor 102 may implement a software program, such as code generated manually (i.e., programmed). In one embodiment, the software may be configured for receiving, transmitting, developing, or analyzing any medical data. The medical data is monitored such that log files are maintained as a record of the processes or procedures performed related to the system 100. For example, the SYNGO system is a software platform configured to offer a consistent implementation on a variety of imaging devices across all diagnostic and therapeutic cycles. SYNGO offers a common user interface across multiple medical imaging applications. SYNGO may be implemented to record and store log files relating to the operation of the imaging devices and/or the operation of the SYNGO software running the device. Accordingly, SYNGO may benefit from the embodiments discussed below.

The memory 106 is a computer readable storage media. Computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the instructions are stored on a removable media drive for reading by a medical system or a workstation networked with similar systems. A medical system or work station uploads the instructions. In another embodiment, the instructions are stored in a remote location for transfer through a computer network or over telephone lines to the diagnostic system or workstation. In yet other embodiments, the instructions are stored within the medical system on a hard drive, random access memory, cache memory, buffer, removable media or other device. In one embodiment, the memory 106 includes a random access memory for the processor 102. In alternative embodiments, the memory 106 is separate from the processor 108, such as a cache memory of a processor, the system memory, the database 108 or other memory. The memory 106 may be operable to store medical data.

The memory 106 is operable to store instructions executable by the processor 102. The instructions may include a method for storing log files and burning the log files to an external medium or transferring them over a network. The functions, acts or tasks illustrated in the figures or described herein are performed by the programmed processor 102 executing the instructions stored in the memory 106. The functions, acts or tasks are independent of the particular type of instructions set, storage media, processor or processing strategy and may be performed by software, hardware, integrated circuits, film-ware, micro-code and the like, operating alone or in combination. Likewise, processing strategies may include multiprocessing, multitasking, parallel processing and the like.

In one embodiment, the system 100 may include a database 108. In an alternate embodiment, the database 108 may merely be part of the memory 106, such that the memory 106 maintains a database configured to store data. The database 108 may store any form or type of data. In one embodiment, the database 108 stores medical data related to diagnosis, treatment, analysis, or any medical procedure. The recorded medical data may be stored on the database 108, along with log files regarding the events of a medical procedure as discussed above. The log files may include any or all system data related to the medical procedure including all steps taken by the user or clinician performing the procedure.

Log files may also be used for backing up a system in the event of a system failure. Stored log files may be used to store newer versions of data. If the system 100 fails, then the backup files may be used to re-establish the system 100 to the state it was at before the failure. Likewise, the log files may include the events or commands used by the system 100 before a failure. These events and commands can be recreated up to the point of the failure.

Log files may include a variety of different data. As discussed above, log data may be information regarding events performed by the processor or system. For example, every keystroke or mouse input in a personal computer may qualify as an event, which is stored as log data. Likewise, the statistical information regarding the function of a system may be log data. Alternatively, log data may be the operating system processes that occur behind the scenes in a computing device, such as the specific functions of the processor. The log data may include configuration, operation or output parameters for medical imaging systems or other medical related systems. Every change in the memory 106 may be recorded as log data, so that there is a record of the state of the memory 106 in the past. Variations of the log data are contemplated in the present embodiments. The use of log data may be valuable for medical devices and equipment such as imaging for monitoring the imaging process. In that case, the log data may function as a record of each event throughout the imaging process.

The system 100 may include a display 110 coupled with the processor 102 and configured to display log files stored in the database 108 or the memory 106. A user burning log files onto an external medium may view the listing of the log files on the display 110. The display 110 may act as an interface for the user to see the functioning of the processor 102, or specifically as an interface with the software. In the embodiment of a medical system coupled with the processor, the medical data related to the system may be displayed as numbers, text, a graph, or an image on the display 110. The data may also be stored in the memory 106 or the database 108. The display 110 may be a CRT, monitor, flat panel, plasma, LCD, projector, printer or other now known or later developed display device for outputting determined information. For example, the processor 102 may cause the display 110 at a local or remote location to output data related to a medical procedure. Likewise, the display 110 may output a listing of relevant log files along with options for organizing or burning the log files.

The system 100 may further include a communication port 104. The communication port may be a part of the processor 102 or may be a separate component. The communication port 104 may be created purely in software or may be a physical connection in hardware. The communication port 104 is configured to connect with a network 112, external media 114, or combinations thereof. The connection with the network 112 may be a physical connection, such as a wired Ethernet connection or may be established wirelessly as discussed below. Likewise, the connection with the external media 114 may be a physical connection or may be established wirelessly.

The network 112 may include wired networks, wireless networks, or combinations thereof. The wireless network may be a cellular telephone network, an 802.11, 802.16, 802.20, or WiMax network. Further the network may be a public network, such as the Internet, a private network, such as an intranet, or combinations thereof, and may utilize a variety of networking protocols now available or later developed including, but not limited to TCP/IP based networking protocols.

The external media 114 may be coupled with the communication port 104 as in FIG. 1. The external media 114 may be any storage device for digital data. Examples include a compact disc (“CD”), digital video disc (“DVD”), memory card, memory stick, floppy disc, universal serial bus (“USB”) memory device, or any other device operative to store digital data. Further, the external media 114 may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the communication port 104 serves as an interface between the processor 102 and the external media 114.

FIG. 2 is a flowchart diagram showing one embodiment for storing log files. The method shown in FIG. 2 may utilize system 100 from FIG. 1 or a different system. The embodiment includes three acts for transferring or burning log files onto an external media 114. As discussed above, log files are recorded to the database 108 or the memory 106. The embodiment disclosed in FIG. 2 is a simplified method for burning log files stored on the system 100.

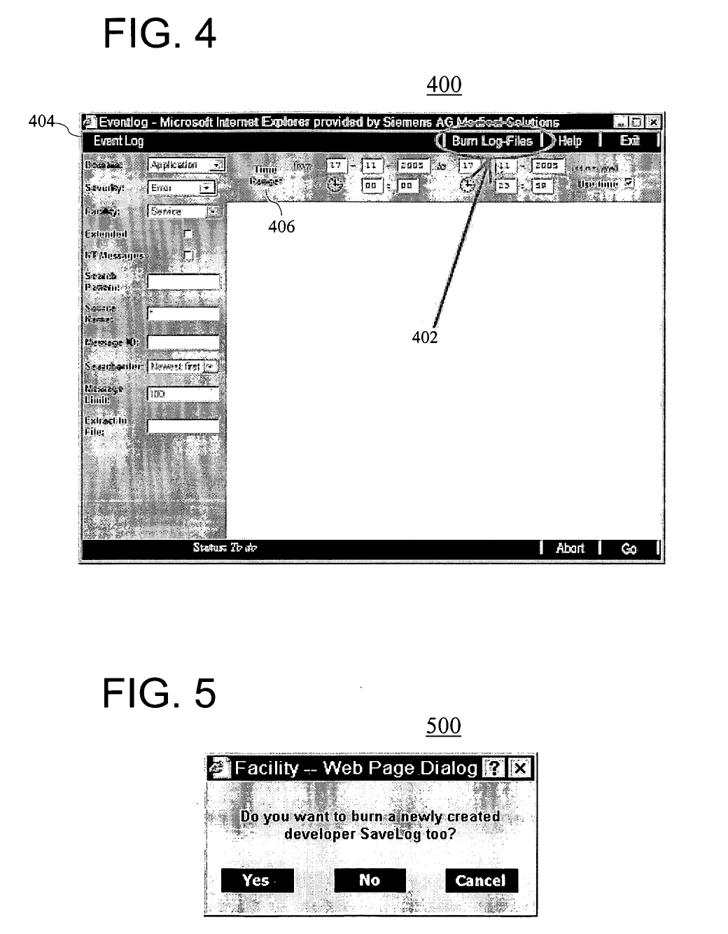

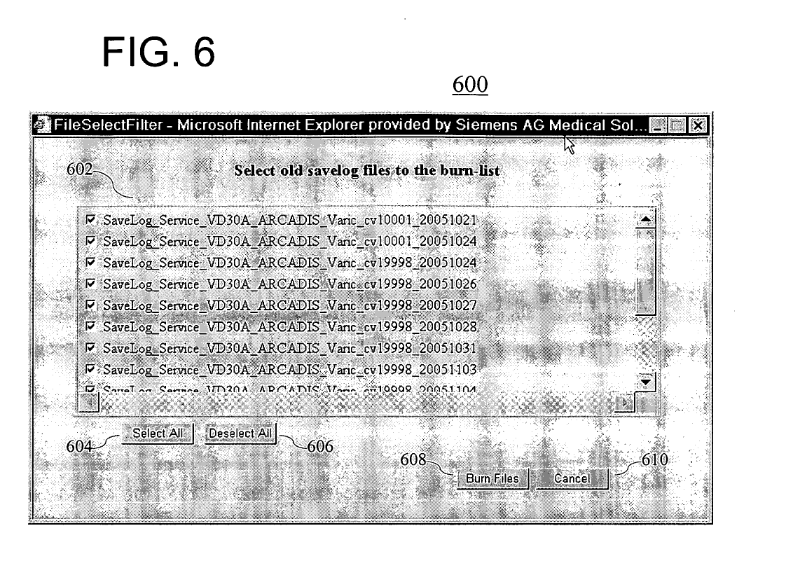

The first step in act 202 is to open the software and select an option for burning log files. As discussed above, the user is provided with a simple selection for beginning the process of transferring log files to an external media 113. Figure 4 is an image of one step of an embodiment of storing burn logs. The screen 400 may include an event log that can be used to sort log files based on different settings. Likewise, the time range 406 allows the log files to be sorted according to time. Therefore, if a system failure occurred within the last week, the user can limit the burning to only log files from the previous week. The screen 400 includes a burn log files option button 402 for beginning the process of transferring log files to an external media 114. The burn log files option button 402 may be a button, menu, drop-down menu, link, or any other mechanism allowing the user to choose to burn log files. In one embodiment, the screen 400 merely displays all events or log files and the log files to be transferred to an external media are sorted and selected according to FIG. 6.

FIG. 4 is illustrative of a software program or application that is configured to record log files and allow the user flexibility in viewing and selecting the recorded events to be burned to an external media 114. In one embodiment, the graphical user interface or screen 400 may be a secondary application running off a master software program. For example, the software platform may include this application to monitor the events that occur at any point in the system. Alternatively, software platforms may include built-in functionality incorporating the features of screen 400 into the operation of the software. Accordingly, the burn log files button 402 in screen 400 may be a free coded implemented program embedded into another software program. One example of such a software program is SYNGO. SYNGO is a SIEMENS universal software platform for use with a variety of medical imaging systems, such as a CT scan, MRI, ultrasound, or other imaging system.

Referring back to FIG. 2, after the user selects to burn log files in act 202, the user is then given the option to generate a save log or SaveLog with dialog box 500 from FIG. 5. FIG. 5 is an image of an additional step of an embodiment for storing burn logs. Specifically, dialog box 500 asks the user whether a newly created developer SaveLog should be burned. The user can choose to burn a SaveLog.

A SaveLog may be a defined pool of information that is stored together in a log file. This particular log file may be generated for each day the system has been in use. In one embodiment, the log file contains an event log such as information on the use of a unit with occurred failures. Alternatively, in one embodiment, a SaveLog may be data from a flight recorder, which stores detailed information of software communication from a recent short period of time, such as the most recent 15 minutes that the system has been in use. The flight recorder is similar to the flight recorder in an airplane because it monitors large amounts of information that has occurred most recently. In the flight recorder embodiment, the SaveLog is the most recent data from a certain time period. The most recent data overwrites the older data, so the flight recorder maintains only data covering the most recent time period. If a new flight recorder data, or SaveLog is to be burned with the log files, then the user clicks on “Yes” to create a new SaveLog. Because the flight recorder covers only a short period of time, such as the last 15 minutes, it may be necessary to burn the flight recorder data, or SaveLog frequently if the user would like to capture all of that data on an external medium. If the user clicks “No” then a SaveLog file is not burned and the filter screen 600 of FIG. 6 appears allowing the user to choose between available stored files for burning. A selection of specific files or events is possible as discussed below.

Whether or not the user selects to burn a SaveLog, the user is presented with an option for selecting log files to burn to an external media as in act 206. Specifically, as discussed above, and as shown in FIG. 6, the user may be presented with a listing of events or log files to be burned to an external media 114. The filter screen 600 shown in FIG. 6 allows a user to select files based on various factors. As discussed above, the files may be organized by date. The listing 602 of events allows a user to select events one-by-one. Alternatively, the user may choose a select all button 604 for burning all of the files, or choose a deselect all button 606 for choosing none of the files. A selection of individual files can be made by clicking directly into the check box of individual files. For example, a user may click on “deselect all” and than click into each check box to select several files. The user can exit the burning process by clicking the cancel button 610. If the user has selected the log files to be burned, the burn files button 608 is clicked to begin the burning process for transferring the selected log files to an external media.

Act 206 allows for the user to select the log files that should be transferred to the external media. Accordingly, the selected log files are transferred to a readable CD, a recordable CD, a recordable DVD, a memory stick, or any other memory device. In one embodiment, there may be an additional option for choosing where to burn the log files. Alternatively, the location of the external media 114 may be set according to the options within a particular system 100. For example, the default external media 114 may be a CD-RW drive or other memory device. In that case the log files are automatically burned to that location unless the location is changed. As discussed above, the memory device allows for convenient transfer of log files to run tests on the equipment or software that is recording the log files. For example, for software running an imaging device, the log files may be recorded to a database 108. Upon choosing to burn selected files, the selected event log files are transferred from the database 108 through the communication port 104 to be burned onto an external media 114 for backup or diagnosis of any potential errors. In one embodiment, the transferring of files may be nececessary for some systems that are mobile or systems without a convenient network connection. The burn procedure may be an alternative way without a network/remote connection to collect a pool of important information and store it at an external medium for shipment. Alternatively, the log files may be transmitted over a network such as through email.

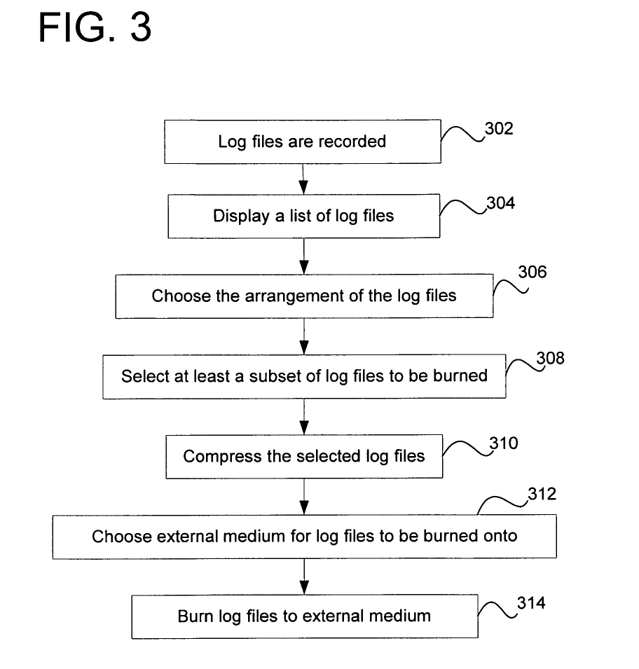

FIG. 3 is a flowchart diagram showing an alternate embodiment for storing burn logs. The log files are recorded in act 302 and displayed as a list in act 304 as discussed above. Screen 400 in FIG. 4 may be a display that lists the events or log files. As shown on the event log 404 and the time range 406, the displayed events can be arranged by time or by other factors in act 306. In an alternate embodiment, the arrangement of the log files may be chosen in the filter screen 600 of FIG. 6. The user selects the log files to be burned in act 308. The selected log files are then compressed in act 310. The compression may be accomplished by creating a ZIP file of all the log files. Alternatively, any now known or later developed compression methods may be used for the compression of the log files. The user may then have the option for choosing the location to which the log files are to be burned or transferred in act 312. Specifically, the user may select any of a plurality of external media such as CD, DVD, memory cards, or any other memory devices. Finally, in act 314, the selected log files are burned onto the selected external medium. In an alternate embodiment, the selected log files may be transferred over a network as a way of transmitting the log files.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive or limiting, and the appended claims are intended to cover all such modifications, enhancements, and other embodiments, which fall within the true spirit and scope of the present invention. Thus, to the maximum extent allowed by law, the spirit and scope of the present invention is to be determined by the broadest permissible interpretation of the following claims, including all equivalents, and shall not be restricted or limited by the foregoing detailed description.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

1. A method of storing log files in a computer comprising:
maintaining a database of log files, wherein each of the log files is a record of at least one event;
displaying at least a portion of the log files;
allowing a selection of at least one log file to be burned;
compressing the selected at least one log file; and
transferring the compressed selected at least one log file to an external medium.

2. The method of claim 1, wherein the at least one event is a function performed by the computer.

3. The method of claim 1, wherein the external medium is a compact disc, digital video disc, memory card, memory device, or combinations thereof.

4. The method of claim 1, wherein the at least one log file relates to medical data, a medical diagnosis, a medical procedure, or combinations thereof.

5. The method of claim 1, wherein the log files are recorded during operation of the computer.

6. A system for transferring log files comprising:
a processor;
a database coupled with the processor for storing log files;
a display coupled with the processor and configured to display a list of at least one of the stored log files;
a communication port coupled with the processor; and
external media coupled with the processor and configured to receive selected log files through the communication port.

7. The system according to claim 6, wherein the processor is further coupled with a medical device.

8. The system according to claim 7, wherein the log files relate to the operation of the medical device.

9. The system according to claim 6, wherein the communication port is coupled with a network.

10. The system according to claim 9, wherein the communication port is configured to transmit selected log files over the network.

11. The system according to claim 6, wherein the processor is configured to compress the selected log files.

12. The system according to claim 11, wherein the compressed log files are transmitted to the external media, over the network, or combinations thereof.

13. The system according to claim 6, wherein the external media is a compact disc, digital video disc, memory card, memory device, or combinations thereof

14. A system for storing and transferring medical log files comprising:
a medical device configured to generate medical data;
a processor coupled with the medical device and configured to process the medical data;
a communication port coupled with the processor and configured to transmit and receive the medical data;
a database coupled with the processor for storing the medical data, the medical data including log files, the log files including events from the medical device or the processor;
a display coupled with the processor and configured to display a list of the log files that can be selected and transferred; and
external media coupled with the communication port and configured to receive the selected log files from the database through the communication port.

15. The system according to claim 14, wherein the selected log files are compressed.

16. In a computer readable storage medium having stored therein data representing instructions executable by a programmed processor for transferring log files for medical software, the storage medium comprising instructions for:
recording a log of events in the medical software;
providing a mechanism in the medical software for displaying the event log;
allowing for a selection of events from the displayed event log; and
burning the selected event log files to an external media.

17. The instructions of claim 16 further comprising:
compressing event log files associated with the selected events.

18. The instructions of claim 16, wherein the at least one event is at least one function of the medical software.

19. The instructions of claim 16, wherein the log files are recorded during operation of the medical software.

20. The instructions of claim 16, wherein the external medium is a compact disc, digital video disc, memory card, memory device, or combinations thereof.

21. The instructions of claim 16 further comprising:
transferring the selected event log files over a network.
